(19) United States
(12) Patent Application Publication
(10) Pub. No.: US 2012/0085205 A1
(43) Pub. Date: Apr. 12, 2012

(54) Universal Trimmer Handle Assembly

(76) Inventor: Christopher Lane Quick, Hanceville, AL (US)

(21) Appl. No.: 13/214,180

(22) Filed: Aug. 20, 2011

Related U.S. Application Data
(60) Provisional application No. 61/392,116, filed on Oct. 12, 2010.

(51) Int. Cl. A01D 34/82

(52) U.S. Cl. 81/489

(57) ABSTRACT

A universal trimmer handle assembly for grass trimmers is provided. An exemplary embodiment may include a bolt, a sleeve, a handle, a clamp, and a knob. When the knob is turned in one direction, the bolt squeezes the handle against the sleeve, forces a tapered portion of the sleeve into a tapered groove of the clamp, and squeezes the clamp together around a trimmer shaft. As a result, the handle is prevented from rotating or sliding with respect to the sleeve, the sleeve is prevented from rotating with respect to the clamp, and the clamp is prevented from sliding or rotating with respect to the trimmer shaft. When the knob is turned in an opposite direction, the handle may be rotated or slid with respect to the sleeve and the clamp may be rotated or slid with respect to the trimmer shaft.

### BACKGROUND

1. Technical Field

The present invention relates generally to trimmer handles for grass trimmers.

2. Description of the Related Art

Grass trimmers, such Weed Eater® trimmers, are well known in the art and used by consumers to trim grass around trees, fences, and other objects. These trimmers, however, typically include one-size-fits-all trimmer handles that are not adjustable. As a result, many consumers are forced to bend over when using these devices and that can result in back pain for the consumers.

### SUMMARY

A universal trimmer handle assembly that alleviates the problems with trimmer handles for grass trimmers is provided. An exemplary embodiment of the universal trimmer handle assembly may include a bolt, a sleeve, a handle, a clamp, and a knob. The clamp may be resilient and may be snapped onto the trimmer shaft of a grass trimmer. The sleeve may be connected to the clamp using a tapered portion on one end of the sleeve and a tapered groove defined in the clamp. The bolt may be disposed within the sleeve and may include a bolt shaft that passes through one end of the sleeve and the clamp. The handle may be partially disposed in and extend through the sleeve and the bolt. The knob may be connected to the shaft that extends out of the clamp.

When the knob is turned in one direction, the assembly may be tightened and the bolt may squeeze the handle against the sleeve, force the tapered portion of the sleeve into the tapered groove of the clamp, and squeeze the clamp together around the trimmer shaft. As a result, the handle may be prevented from rotating or sliding with respect to the sleeve, the sleeve may be prevented from rotating with respect to the clamp, and the clamp may be prevented from sliding or rotating with respect to the trimmer shaft. When the knob is turned in an opposite direction, the assembly may be loosened and the handle may be rotated or slid with respect to the sleeve and the clamp may be rotated or slid with respect to the trimmer shaft. As a result, the handle may be positioned so that a user can grasp the handle and use the grass trimmer without bending over.

Other features and/or advantages of this disclosure will be or may become apparent to one with skill in the art upon examination of the following drawings and detailed description. It is intended that all such additional methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 includes a side view, a cut-away end view, and an exploded perspective view of an exemplary embodiment of the present invention.

FIG. 2 includes a first side view, a second side view rotated 90 degrees with respect to the first side view, and an end view of an exemplary embodiment of a bolt included with the present invention.

FIG. 3 includes a front view, a cut-away side view, a side view, a front perspective view, and a back view of an exemplary embodiment of a sleeve included with the present invention.

FIG. 4 includes a cut-away side view, a front view, and a side view of an exemplary embodiment of a clamp included with the present invention.

FIG. 5 includes a cut-away side view, a front view, a side view, a back view, a top view, a front perspective view, and a back perspective view of a second exemplary embodiment of a clamp included with the present invention.

FIG. 6 includes a side view, a cut-away end view, and an exploded perspective view of a second exemplary embodiment of the present invention.

FIG. 7 includes a first side view, a second side view rotated 90 degrees with respect to the first side view, a cut-away side view, a front view, and an end view of a second exemplary embodiment of a bolt included with the present invention.

### DETAILED DESCRIPTION

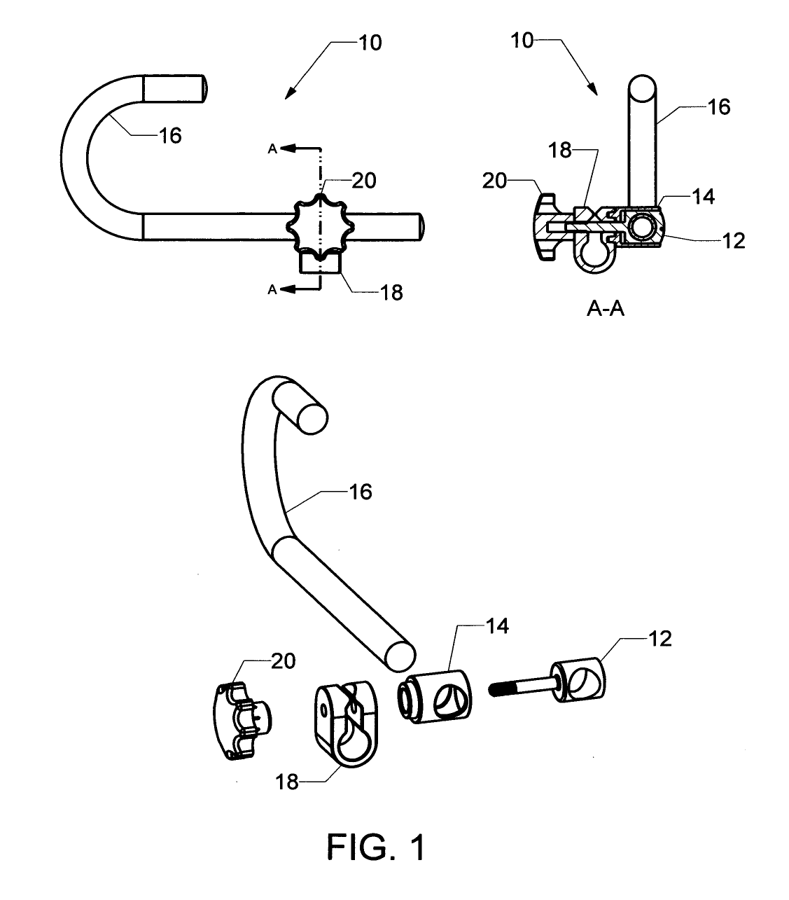

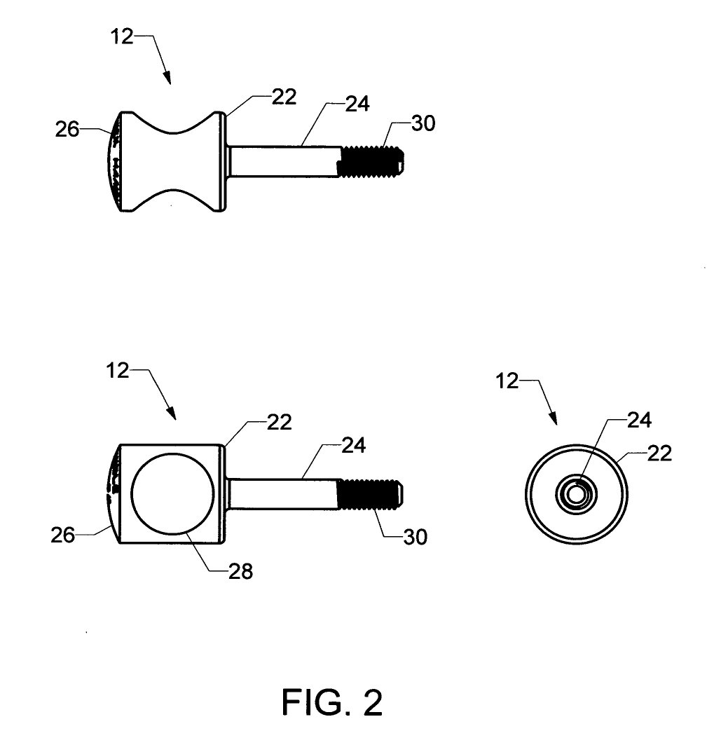

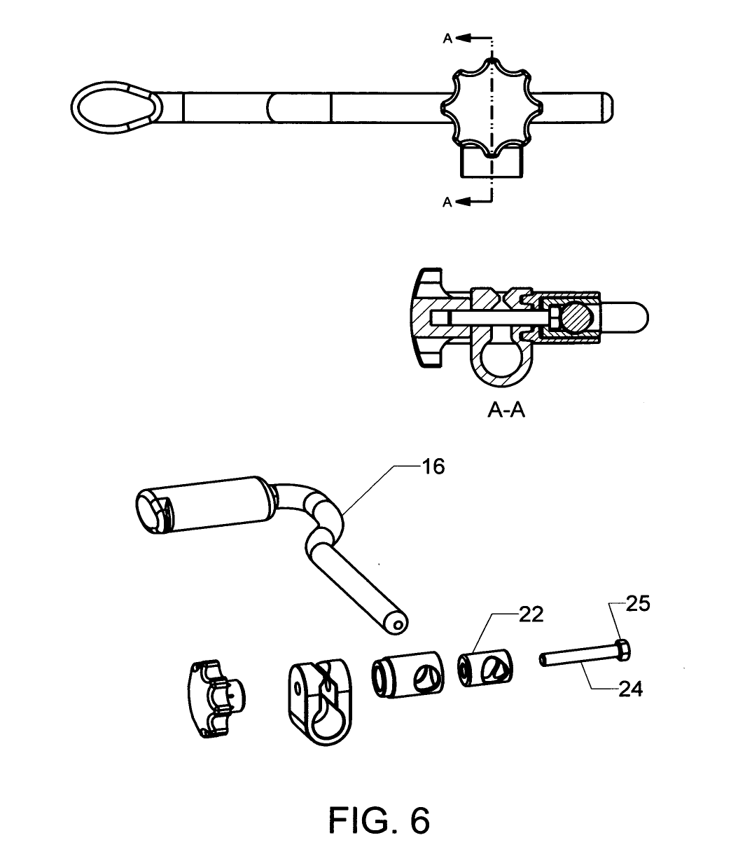

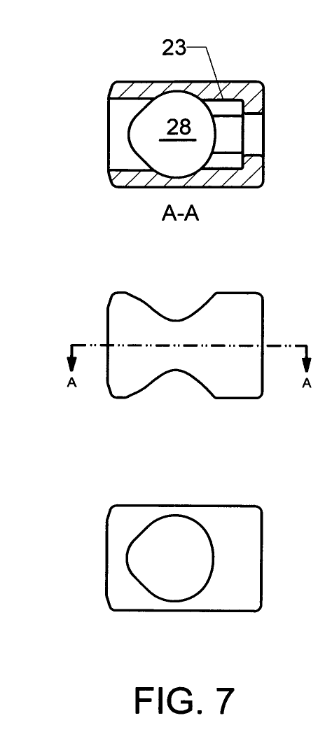

As shown in FIGS. 1-3, an exemplary embodiment of the universal trimmer handle assembly 10 may include a bolt 12, a sleeve 14, a handle 16, a clamp 18, and a knob 20. The bolt 12 may include a cylindrical bolt body 22 and a cylindrical bolt shaft 24. The bolt body 22 may include a curved end portion 26 and a bolt body handle opening 28 defined therein. The bolt shaft 24 may include a threaded portion 30. Referring to FIGS. 6 and 7, the cylindrical bolt shaft 24 may be physically separate from the cylindrical bolt body 22 and include a hex head 25, with the cylindrical bolt body 22 including a hex head recess 23 for receiving and capturing the hex head 25 and the bolt body handle opening 28 being egg-shaped.

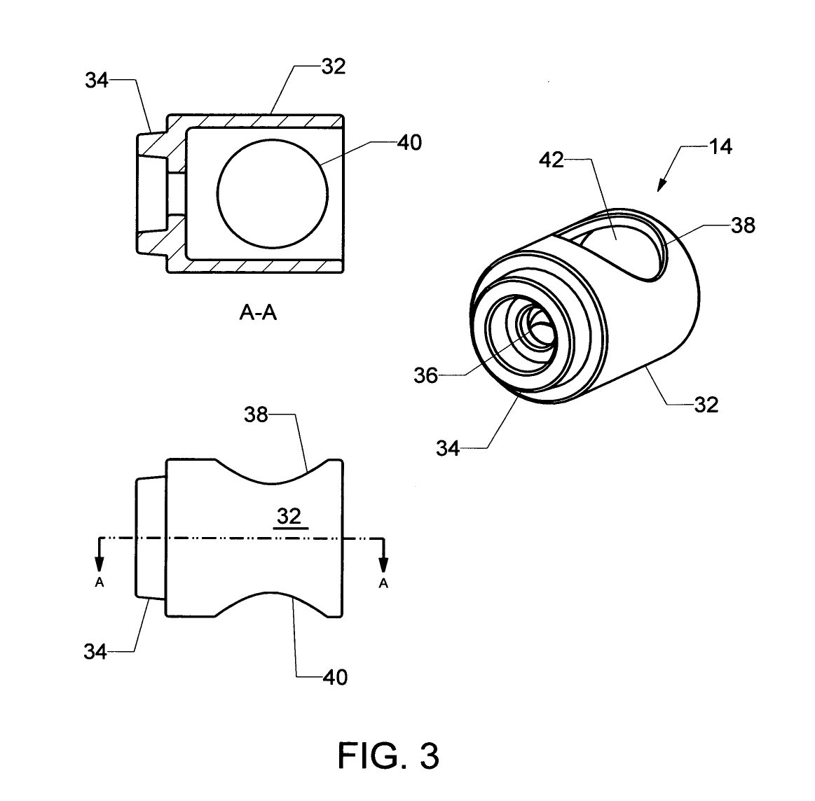

Turning now to FIG. 3, the sleeve 14 may include a cylindrical, hollow, sleeve body 32, an annular tapered portion 34 defined in one end of the sleeve body 32, a bolt shaft opening 36 defined in the end of the sleeve body 32 including the tapered portion 34, and two sleeve handle openings, 38 and 40, defined in the sleeve body 32. The two sleeve handle openings, 38 and 40, may be positioned in the sleeve body 32 opposite from one another and the bolt shaft opening 36 may be concentric with the annular tapered portion 34. The bolt 12 and the sleeve 14 may both be manufactured out of 6061 aluminum.

Sleeve body 32 may be sized so that the bolt 12 may be inserted into the sleeve body 32, with the bolt shaft 24 passing through the bolt shaft opening 36 of the sleeve body 32 and the bolt body 22 being disposed in a hollow portion 42 of the sleeve body 32. When the bolt 12 is inserted in this manner, the sleeve body 32 and the bolt 12 may also be sized so that the bolt 12 rotates freely inside the hollow portion 42 of the sleeve body 32, the bolt body handle opening 28 may be aligned with the two sleeve handle openings, 38 and 40, defined in the sleeve body 32, and the bolt 12 may be slid toward the end of the sleeve body 32 including the annular tapered portion 34 to a point where the bolt body handle opening 28 and two sleeve handle openings, 38 and 40, become misaligned.

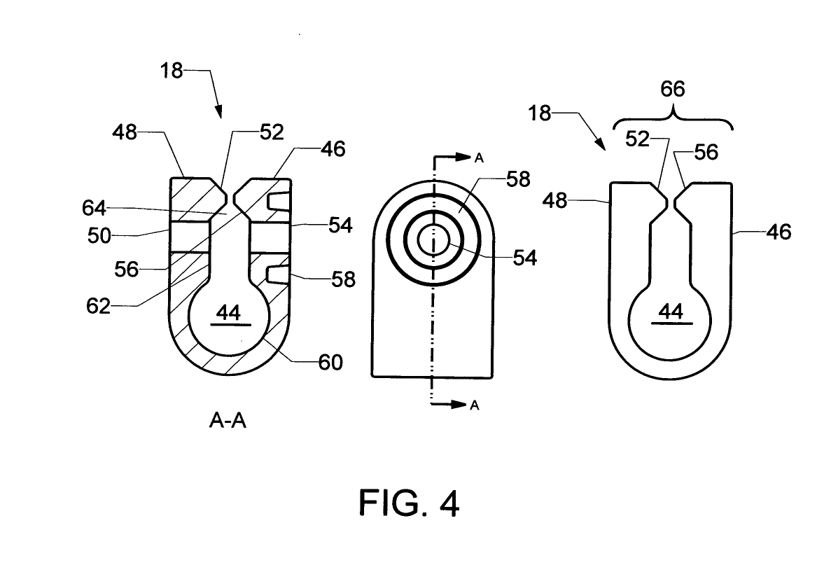

The clamp 18 (FIG. 4) may be u-shaped and resilient to facilitate snapping the clamp 18 onto a trimmer shaft of a grass trimmer. The clamp 18 may include a trimmer shaft opening 44 and two leg portions, 46 and 48. The leg 48 may include a first bolt opening 50 and a first ridge portion 52 defined therein. The leg 46 may include a second bolt opening 54, a second ridge portion 56, and an annular tapered groove 58 defined therein. The trimmer shaft opening 44 may be keyhole shaped and include a circular portion 60 and a narrow portion 62 having a tapered end 64.

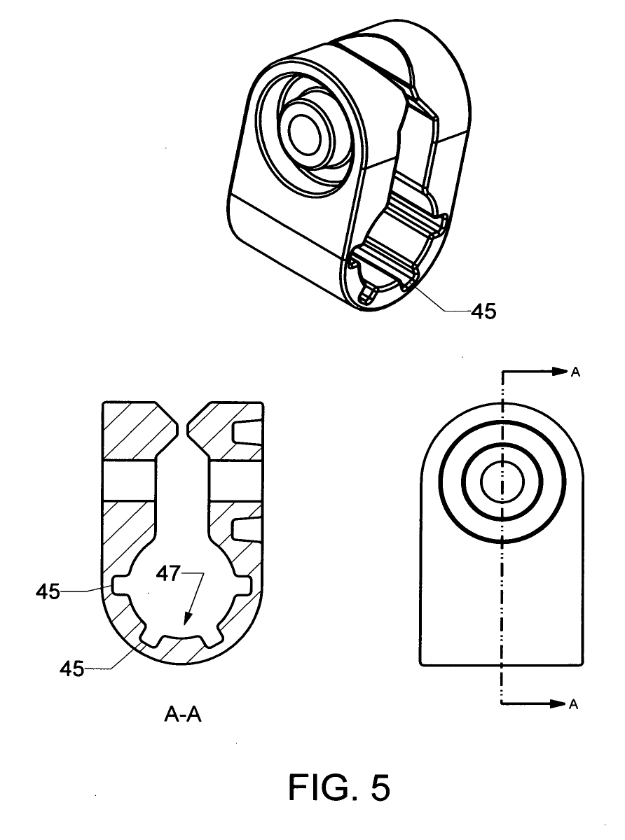

The first ridge portion 52 may be positioned adjacent to and opposite from the second ridge portion 56, the first bolt opening 50 may be positioned adjacent to and opposite from the second bolt opening 54, and the annular tapered groove 58 may be concentric with the second bolt opening 54. The first and second ridge portions, 52 and 56, may form a beveled portion 66 that facilitates snapping the clamp 18 onto a trimmer shaft of a grass trimmer. The clamp 18 may also include a plurality of notches 45 (FIG. 5) defined in an inner surface 47 of the circular portion 60 to further facilitate snapping the clamp 18 onto a trimmer shaft.

The handle 16 may be J-shaped or L-shaped (FIG. 6) and manufactured out of polypropylene or bent aluminum tubing. The knob 20 may be manufactured out of polypropylene and may include an inner threaded portion that can be threaded onto the threaded portion 30 of the bolt 12. The clamp 18 may also be manufactured out of polypropylene.

In use, the clamp 18 may be snapped onto the trimmer shaft of a grass trimmer and the annular tapered portion 34 of sleeve 14 may be partially disposed in the annular groove 58 of the clamp 18. The bolt 12 may be inserted into the hollow portion 42 of the sleeve 14, with the bolt shaft 24 extending through the bolt shaft opening 36 of the sleeve 14 and the first and second bolt openings, 50 and 54, in the clamp 18, and the bolt body 22 being disposed within the hollow portion 42 of the sleeve 14. The bolt body handle opening 28 may be aligned with the sleeve handle openings, 38 and 40, and the handle 16 may be partially inserted through the two sleeve handle openings, 38 and 40, and the bolt body handle opening 28. When the knob 20 is turned in one direction, the assembly 10 is loosened and the handle 16 may be adjusted up or down by a user, i.e., slid upward or downward with respect to the sleeve 14 and the trimmer shaft. The handle 16 may also be rotated with respect to the sleeve 14 and the trimmer shaft. When the knob 20 is turned in an opposite direction, the assembly 10 is tightened and the handle 16 is secured in place with respect to the sleeve 14. As a result, the handle 16 may be positioned so that the user can grasp the handle 16 without bending over when using the grass trimmer.

The knob 20 may be threaded onto the threaded portion 30 extending out from the clamp 18 and turned in one direction until the bolt 12 squeezes the handle 16 against the sleeve 14, forces the annular tapered portion 34 of the sleeve 14 into the annular tapered groove 58 in the clamp 18 (before the knob 20 is tightened in this manner, the sleeve 14 may be rotated with respect to the clamp 18), and squeezes the legs, 46 and 48, of the clamp 18 together around the trimmer shaft. When the knob 20 is turned in this manner, the handle 16 is prevented from sliding and rotating with respect to the sleeve 14, the sleeve 14 is prevented from rotating with respect to the clamp 18, and the clamp 18 is prevented from rotating or sliding with respect to the trimmer shaft. When the knob 20 is turned in an opposite direction, the bolt 12 may be loosened and the handle 16 may be rotated or slid with respect to the sleeve 14 and the clamp 18 may be rotated or slid with respect to the trimmer shaft.

The above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A trimmer handle assembly, comprising:
a sleeve;
a clamp connected to the sleeve;
a bolt disposed within the sleeve and extending through the sleeve and the clamp;
a handle disposed within and extending through the sleeve and the bolt; and
a knob connected to the bolt.

2. The assembly of claim 1, wherein the sleeve includes a sleeve body, a tapered portion defined in one end of the sleeve body, two sleeve handle openings defined in two walls of the sleeve body, a bolt shaft opening defined in the end of the sleeve body including the tapered portion, and a bolt body opening defined in the sleeve body in an end opposite from the end of the sleeve body including the tapered portion.

3. The assembly of claim 2, wherein:
the clamp is connected to the sleeve using the tapered portion defined in the sleeve body;
the handle is disposed within and extends through the two sleeve handle openings defined in the walls of the sleeve body; and
the bolt is disposed within the bolt body opening of the sleeve and extends through the bolt shaft opening of the sleeve.

4. The assembly of claim 3, wherein:
the tapered portion of the sleeve is annular; and
the bolt shaft opening of the sleeve is concentric with the annular tapered portion of the sleeve.

5. The assembly of claim 1, wherein:
the clamp includes a trimmer shaft opening and two leg portions;
one of the leg portions includes a first bolt opening and a first ridge portion defined therein and the other leg portion includes a second bolt opening, a second ridge portion, and a tapered groove defined therein; and
the tapered portion of the sleeve is disposed within the tapered groove of the clamp.

6. The assembly of claim 5, wherein:
the first ridge portion is positioned adjacent to and opposite from the second ridge portion;
the first bolt opening is positioned adjacent to and opposite from the second bolt opening; and
the trimmer shaft opening is keyhole shaped and includes a circular portion and a narrow portion having a tapered end.

7. The assembly of claim 1, wherein:
the bolt includes a bolt body and a shaft extending therefrom;
the bolt body includes a curved end portion and a bolt body handle opening;
the shaft is disposed within a bolt shaft opening defined in the sleeve;
the bolt body is disposed within a bolt body opening defined in the sleeve; and
the bolt body handle opening is misaligned with two sleeve handle openings defined in the sleeve.

8. The assembly of claim 1, wherein:
the handle is J-shaped;
the sleeve is cylindrical;
the bolt is cylindrical; and
the clamp is a u-shaped squeeze clamp that includes a beveled portion at one end and a plurality of notches that facilitate the clamp being snapped onto a trimmer shaft.

9. The assembly of claim 1, wherein:
the sleeve includes an annular tapered portion;
the clamp includes an annular tapered groove; and
the clamp is connected to the sleeve by disposing the annular tapered portion of the sleeve in the annular tapered groove of the clamp.

10. The assembly of claim 9, wherein the annular tapered portion of the sleeve and the annular tapered groove of the clamp prevent the sleeve from rotating with respect to the clamp.

11. The assembly of claim 1, wherein:
the knob includes an inner threaded portion;
the bolt includes a threaded shaft; and
the knob is connected to the bolt by threading the inner threaded portion of the knob onto the threaded shaft of the bolt.

12. The assembly of claim 11, wherein, when the knob is threaded onto the threaded shaft of the bolt, the bolt squeezes the handle against the sleeve, thereby preventing the handle from sliding or rotating with respect to the bolt and the sleeve.

13. The assembly of claim 11, wherein, then the knob is threaded onto the threaded shaft of the bolt, the bolt presses the handle against the sleeve and disposes an annular tapered portion defined in the sleeve in an annular tapered groove defined in the clamp.

14. The assembly of claim 11, wherein, when the knob is threaded onto the threaded shaft of the bolt, the sleeve and the bolt squeeze the clamp onto a trimmer shaft, thereby preventing the clamp from sliding or rotating with respect to the trimmer shaft.

15. The assembly of claim 1, wherein:
the handle is L-shaped;
the bolt includes a bolt body having a hex recess defined therein and a shaft having a hex head on one end;
the hex head is disposed within and captured by the hex recess defined in the bolt body; and
the clamp is a u-shaped squeeze clamp that includes a plurality of notches that facilitates the clamp being snapped onto a trimmer shaft.

16. The assembly of claim 1, wherein, when the knob is turned in one direction, the assembly is loosened and the handle may be slid upward, downward, or rotated with respect to the sleeve and, when the knob is turned in an opposite direction, the assembly is tightened and the handle is secured in place with respect to the sleeve.
